(19) United States
(12) Patent Application Publication
(10) Pub. No.: US 2007/0060474 A1
(43) Pub. Date: Mar. 15, 2007

(54) Cleansing method of electrochemical plating cell

(76) Inventor: Ji Ho Hong, Suwon-city (KR)

Correspondence Address: MCKENNA LONG & ALDRIDGE LLP, 1900 K STREET, NW, WASHINGTON, DC, 20006, US

(21) Appl. No.: 11/320,976

(22) Filed: Dec. 30, 2005

(30) Foreign Application Priority Data
Sep. 13, 2005 (KR) 2005-0085106

(51) Int. Cl. B01J 23/00

(52) U.S. Cl. 502/351

(57) ABSTRACT

A cleansing method of an electrochemical plating cell includes the steps of preparing a cleansing liquid composed of some or all of components of an electrolyte used in a preceding plating process; and contacting the prepared cleansing liquid to a cleansing object or a cleansing portion.

### CROSS-REFERENCE TO RELATED APPLICATION

This application claims the benefit of Korean Patent Application No. P2005-85106, filed on Sep. 13, 2005, which is hereby incorporated by reference as if fully set forth herein.

### BACKGROUND OF THE INVENTION

1. Field of the Invention

The present invention relates to a cleansing method for semiconductor equipment, and more particularly, to a cleansing method for an electrochemical plating cell.

2. Description of the Related Art

Methods of forming a metal layer on a wafer in a semiconductor fabrication process usually include an electrochemical plating method using an electrochemical plating cell.

FIG. 1 is a longitudinal sectional perspective view of a conventional electrochemical plating cell.

Referring to FIG. 1, an electrochemical plating cell includes a container 10. The upper portion of the container 10 is open to contain and support a wafer holder 12. The container 10 may be a ring-shaped cell made of an insulating material such as plastic, plexiglass (acrylics), lexan, PVC, CPVC, or PVDF.

The wafer holder 12 is used as an upper cover of the container 10. The container 10 normally has the shape and size corresponding to a wafer W. An inlet is provided at the lower surface of the container 10 for inflow of an electroplating liquid (not shown) therethrough. The electroplating liquid is supplied to the container 10 by a pump (not shown) connected with the inlet and contacts the surface of the wafer W.

A cathode contact member 14 is disposed at the lower surface of the wafer holder 12 to supply a current onto the surface of the wafer W for an electroplating process.

As shown in FIG. 2, the cathode contact member 14 includes a body 14a and a contact strip (or contact pins) 14b which protrudes from the body 14a and contacts the wafer W. The cathode contact member 14 transfers electrical energy supplied by an external power supply (not shown) to the wafer W. The contact pins 14b contact the edge portion of the wafer W.

In addition, the container 10 includes a chamber 18. A consumable anode 16 is disposed in the chamber 18 to provide a metal supplying source. Although not shown, the consumable anode 16 includes of a metal part such as pure copper that is enclosed by a porous cover, a metal wire, and a perforated or solid state metal sheet, and is electrically connected with the power supply.

In the cathode contact member 14, the contact pins 14b generally have the same protrusion length L. Referring to FIG. 2, a portion indicated by black at the end of the contact pins 14b contacts the wafer W. The contact portion between the wafer W and the cathode contact member 14 is typically formed less than 2 mm inward from the edge of the wafer W.

However, during a plating process using the electrochemical plating cell, a large amount of metal particles are created and accumulated in the cell for various reasons. The particles are particularly accumulated on the contact portion between the wafer W and the cathode contact member 14, that is, on the surface of the contact pins 14b in great quantities.

The electrochemical plating cell is classified as a wet contact method or a dry contact method according to the contact method with respect to the cathode contact member 14. As shown in FIG. 3, in the wet contact method, the contact portion between the wafer W and the cathode contact member 14 is exposed to an electrolyte. As shown in FIG. 4, in the dry contact method, the contact portion between the wafer W and the cathode contact member 14 is sealed with an encapsulation member 41 to prevent the electrolyte from being exposed.

In the wet contact method, during a copper (Cu) plating process, Cu particles accumulate on the surface of the cathode contact member 14 for plating, but particle residuals plated on the cathode contact member 14 are removed by a deplating process in which a plating current is inversely applied.

Meanwhile, in the dry contact method, even if the contact portion is sealed, particles such as CuSO4 crystals and Cu oxide materials continuously accumulate on the surface of the cathode contact member 14 due to remaining electrolytes. Thus, a contact resistance increases due to the particles accumulated on the cathode contact member 14, which leads to a quality deterioration of the electrochemical plating cell. To prevent this, a method in which the contact pins 14b of the electrochemical plating cell are cleaned one at a time with a wiper soaked in de-ionized water has been used. However, this method is problematic in that a cleansing cycle is very short, and the number of particles remaining after a completed cleansing process is great.

### SUMMARY OF THE INVENTION

In order to solve the aforementioned problems with the conventional process, the present invention provides a cleansing method for an electrochemical plating cell, in which residual metal accumulated in a cell and particularly in a cathode contact member can be effectively removed during an electrochemical plating process using an electrochemical plating cell.

According to an aspect of the present invention, there is provided a method of cleansing an electrochemical plating cell comprising the steps of preparing a cleansing liquid composed of some or all of components of an electrolyte used in a preceding plating process; and contacting the prepared cleansing liquid to a cleansing object or a cleansing portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a longitudinal sectional perspective view of a conventional electrochemical plating cell;

FIG. 2 illustrates a cathode contact member of FIG. 1;

FIG. 3 illustrates a wet contact method;

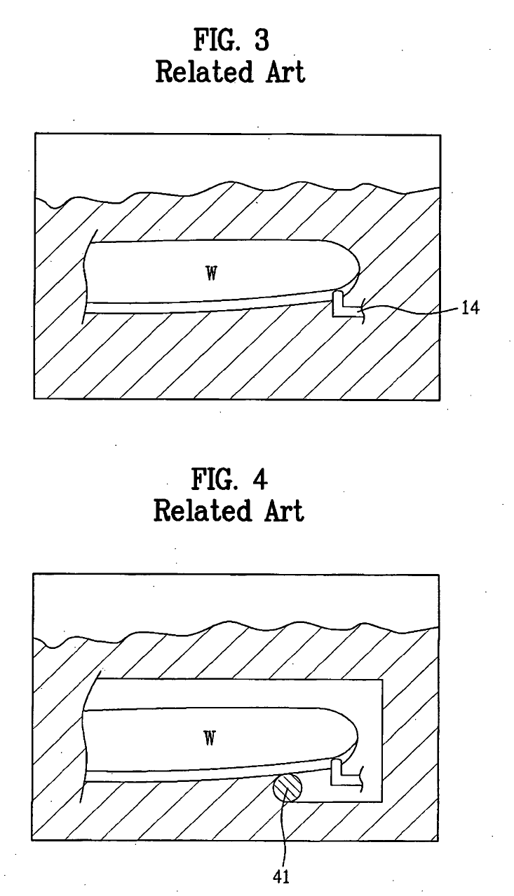

FIG. 4 illustrates a dry contact method;

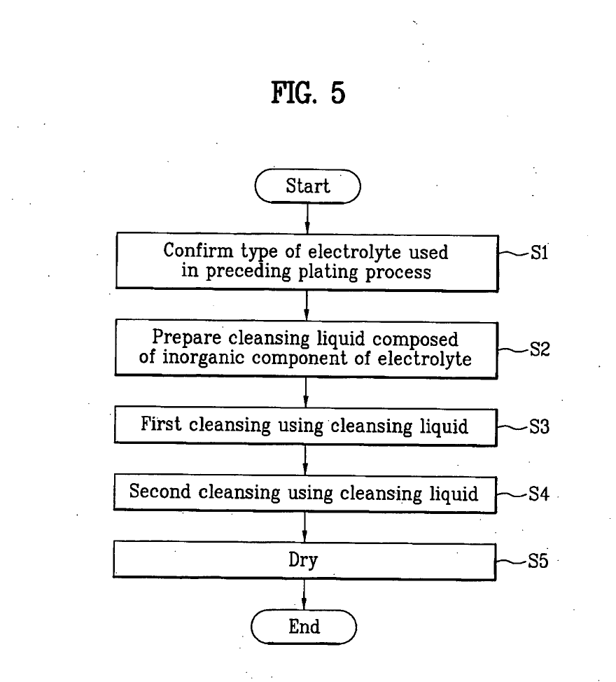

FIG. 5 is a flowchart illustrating a cleansing method of an electrochemical plating cell according to an exemplary embodiment of the present invention; and

FIGS. 6 and 7 are a graph and a chart for comparing cleansing processes of the prior art and the present invention.

### DETAILED DESCRIPTION OF THE PREFERRED EMBODIMENTS

Hereinafter, exemplary embodiments of a cleansing method of an electrochemical plating cell of the present invention will be described in detail with reference to the accompanying drawings.

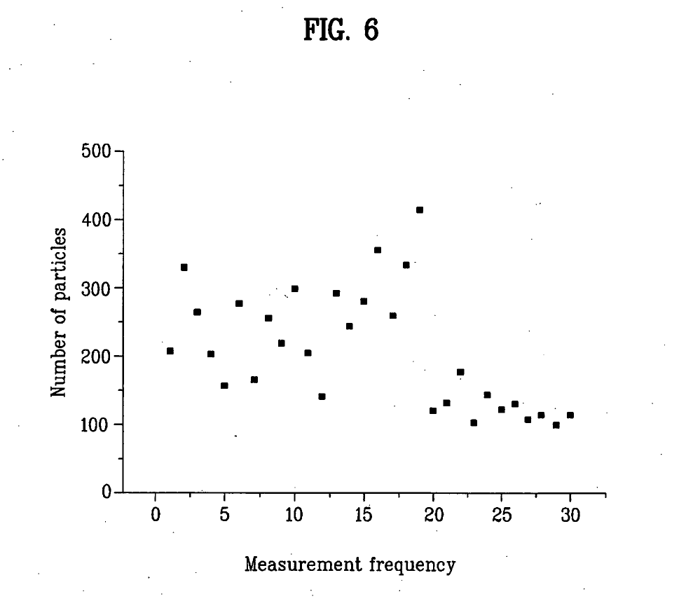

FIG. 5 is a flowchart illustrating a cleansing method of an electrochemical plating cell according to an exemplary embodiment of the present invention, for example a cleansing method for a cathode contact member of an electrochemical plating cell.

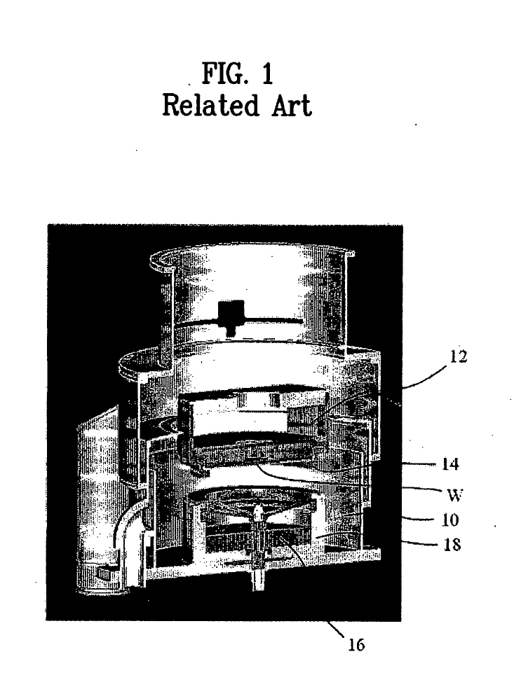

First, when copper plating is completely performed on a semiconductor wafer W using an electrochemical plating cell of FIG. 1, the type of electrolyte used during the plating process is confirmed. The preceding plating process can be, for example, a dry plating method. The electrolyte is composed of an inorganic component and an organic component. The inorganic component is composed of CuSO4, HCl (or CuCl2), and H2SO4. The concentrations of CuS04, Cl, and H2S04 may be 39-41 g/L, 45-55 ppm, and 9-11 g/L, respectively. The organic component is composed of an accelerator and a suppressor (SI).

Next, a cleansing liquid is prepared, which is composed of the inorganic component of the electrolyte, that is, CuSO4, HCl (or CuCl2), and H2SO4. The cleansing liquid may be the electrolyte itself (S2).

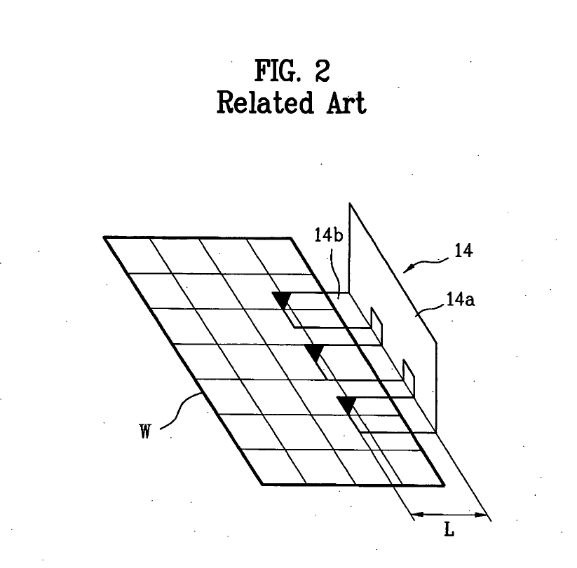

Next, a cleaning object and/or a cleansing portion are cleansed using the prepared cleansing liquid. In the exemplary embodiment, the cathode contact member 14 of FIGS. 1 and 2 is the cleansing object. Generally, the cathode contact member 14 can be separated from the electrochemical plating cell. Thus, during a cleansing process, the cathode contact member 14 is separated from the cell, and is then soaked into the cleansing liquid stored a container (not shown) for about 14 to 34 hours, for example, about 24 hours. The cathode contact member 14 may be rubbed using a soft brush and the like (S3).

Next, the cathode contact member 14 is taken out of the cleansing liquid, and is then cleansed using de-ionized water (S4).

Last, after the cleansing process is completed using the de-ionized water, the cathode contact member 14 is dried (S5).

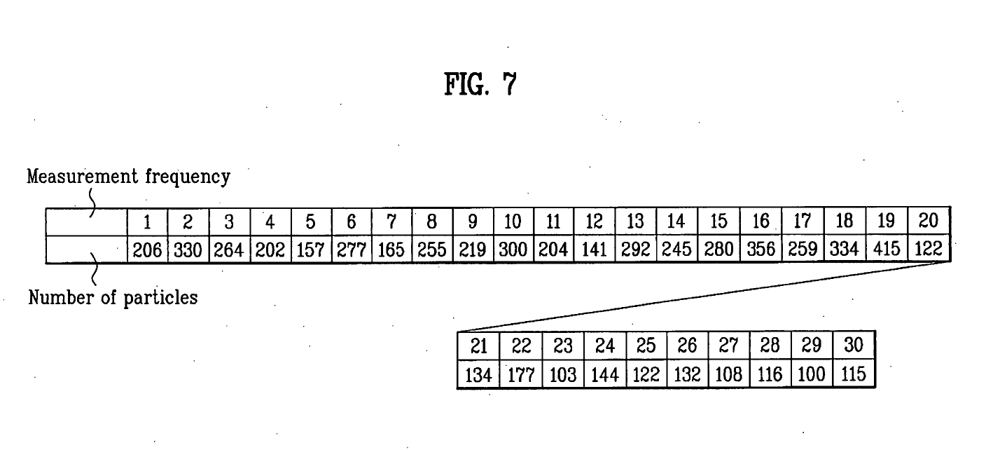

FIGS. 6 and 7 are a graph and a chart for comparing cleansing processes of the prior art and the present invention. The cleansing objects were respectively cleansed at a predetermined cycle according to the prior art and the present invention, and the number of particles remaining on the cleansing objects were measured. The cleansing process of the prior art was measured for 3 times per week with a cleansing cycle of 1 day. The cleansing process of the present invention was measured for 3 times per week with a cleansing cycle of 1 week.

In a graph of FIG. 6 and a chart of FIG. 7, data based on the cleansing process of the prior art is labeled 1 to 9 on the axis of the measurement frequency, and data based on the cleansing process of the present invention is labeled from 20 to 30 in the axis of the measurement frequency. As shown in FIGS. 6 and 7, the cleaning cycle of the present invention has increased from 1 day to 1 week, but the number of particles remaining after the completed cleansing process has been remarkably reduced about 48% with respect to the prior art.

Accordingly, in a cleansing method of an electrochemical plating cell of the present invention, the number of particles accumulated on a cell and/or a cathode contact member during a plating process can be remarkably reduced as compared with the cleansing method of the prior art. Also, a cleansing cycle can be significantly increased. Therefore, the electrochemical plating cell can be effectively maintained and controlled, and a yield of a semiconductor device can be improved.

What is claimed is:

1. A method of cleansing an electrochemical plating cell that has undergone a preceding plating process, the method comprising:
preparing a cleansing liquid composed of at least one of the components of an electrolyte used in the preceding plating process; and
applying the prepared cleansing liquid to a portion of the electrochemical plating cell.

2. The method according to claim 1, wherein the liquid is applied for about 14 to 34 hours.

3. The method according to claim 1, further comprising a step of applying de-ionized water to the portion.

4. The method according to claim 3, further comprising a step of drying the portion after applying de-ionized wafer.

5. The method according to claim 1, wherein the cleansing liquid comprises an inorganic component of the electrolyte.

6. The method according to claim 1, wherein the preceding plating process is a copper plating process and the cleansing liquid comprises CuSO4, Cl, and H2SO4.

7. The method according to claim 6, wherein concentrations of CuSO4, Cl, and H2SO4 are 39-41 g/L, 45-55 ppm, and 9-11 g/L, respectively.

8. The method according to claim 1, wherein the portion is a cathode contact member of the electrochemical plating cell.

9. The method according to claim 1, wherein the preceding plating process uses a dry plating method.

10. The method according to claim 1, wherein the portion is a cathode contact member of the electrochemical plating cell, and wherein the method further comprises removing the cathode contact member from the electrochemical plating cell prior to the contacting step.

11. The method according to claim 1, wherein the liquid is applied for about 24 hours.

12. The method according to claim 1, further comprising rubbing the portion with a soft brush after the contacting step.
